(19) United States
(12) Patent Application Publication
(10) Pub. No.: US 2006/0047557 A1
(43) Pub. Date: Mar. 2, 2006

(54) Techniques for resolving conflicts in scheduling conferences

(76) Inventors: David Bieselin, Menlo Park, CA (US); Randall Ethier, Burke, VA (US)

Correspondence Address: Evans & Molinelli PLLC, 6411 Chapel View Road, Clifton, VA, 20124, US

(21) Appl. No.: 10/958,523

(22) Filed: Oct. 5, 2004

Related U.S. Application Data
(63) Continuation-in-part of application No. 10/931,737, filed on Sep. 1, 2004.

(51) Int. Cl. G06F 9/46

(52) U.S. Cl. 705/9

(57) ABSTRACT

Techniques for scheduling a conference among multiple persons includes receiving a conference request to schedule a particular conference. The conference request includes quorum data and limit data. The quorum data indicates a quorum of persons to conduct the particular conference. The limit data indicates a limit on a property of the particular conference, such as a limit on the date, time, location, language, or travel cost. The method also includes receiving availability data from a shared database that includes information about a recorded commitment of time for each person of a population. Also received is priority data that indicates an importance to an organization that a particular recorded commitment of a particular person is honored. A proposed time interval for the particular conference is determined based on the conference request and the availability data and the priority data.

### CROSS-REFERENCE TO RELATED APPLICATIONS

This application claims benefit as a Continuation-in-part of U.S. patent application Ser. No. 10/931737, (Attorney Docket Number CIS001-001) by Randall Ethier and David Bieselin, filed Sep. 1, 2004 (hereinafter Ethier), the entire contents of which are hereby incorporated by reference as if fully set forth herein, under 35 U.S.C. §120.

### BACKGROUND OF THE INVENTION

1. Field of the Invention

The present invention relates to using a calendar system and other availability data shared among users to schedule conferences (including meetings) among users, and in particular to resolving conflicts in scheduling a conference based on priority of commitments by users.

2. Description of the Related Art

A number of software applications are available for scheduling conferences among busy members of an organization. For example, a commercial meeting scheduling application is available from Meeting Maker Inc. of Waltham, Mass.; and from Latitude of Santa Clara, Calif. (a subsidiary of Cisco Systems Incorporated of San Jose Calif.). These applications have in common a database that stores information related to a calendar of conferences and appointments each member is scheduled to attend. Such a database is herein called a shared electronic calendar. For purposes of the following discussion the term conference includes any simultaneous coming together of multiple parties for communication, whether involving a meeting held in person or involving remote communications, including data, audio, video, or multi- media communications, or some combination of in-person meetings and remote communications.

For example, some systems allow a conference organizing user (the “organizer”) to specify a list of mandatory attendees and a list of optional attendees from the organization. The scheduling application (“scheduler”) then determines one or more proposed times that all the mandatory attendees can attend a meeting based on data in the organization's shared electronic calendar. The proposed times are presented one at a time in chronological order. Some schedulers also list the optional attendees who are also available to attend each proposed time. The organizer then uses the scheduler to send a message to the selected attendees for one of the proposed times, inviting them to attend the meeting. The scheduler receives responses and notifies the organizer who has accepted, who has rejected, and who has not yet responded to the invitation.

While greatly simplifying the task of finding times when a limited number of persons are available for a conference, the existing systems still suffer some deficiencies.

For example, under some circumstances, such as when the list of mandatory attendees is large, the first proposed time may be too distant to be useful for the purposes of the conference. For example, the purpose of the meeting may be to determine what research results to present at an upcoming scientific convention. When the first proposed time is too close to, or after, the start of the convention, the first proposed time is not useful for accomplishing the purpose of the meeting. The existing systems do not give sufficient automatic choices to an organizer to enable the organizer to resolve such a scheduling conflict.

One approach would be for an organizer to identify one or more representative groups of persons without requiring a particular member of the group to attend.

For example, suppose that a conference is desired to determine what research to present at a scientific convention on the topic of possible prion-based diseases above and beyond bovine spongiform encephalopathy (also known as “Mad Cow” disease). In this example, the determination requires the attendance of a scientists in six disciplines including discipline A (protein biochemistry), discipline B ( poultry and wild game bird biology), discipline C (domesticated and wild game swine biology), discipline D (domesticated and wild bovine biology), discipline E (ichthyology), and discipline F (medical pathology). Furthermore, in this example, the organization includes two scientists in each discipline, but due to their busy schedules, as reflected in their electronic calendars, all twelve of these scientists cannot convene for a joint conference until after the scientific convention. Only one person of each pair of scientists in each discipline need attend the pre-convention conference. Thus a minimum of six scientists are needed for a quorum, provided they represent the six disciplines. There are 2⁶ (i.e., 64) combinations of minimum conference attendees which are acceptable in this example.

With extant scheduling systems, an organizer has to enter all 64 combinations manually and obtain one or more proposed dates for each combination. Then the organizer would have to review the 64 or more possible dates and select a best one, e.g., the earliest. This is a tedious, time consuming, and error-prone process. In most instances, the organizer would try a few of the 64 combinations and then either give up or settle for a date that is not optimal.

Even if the organizer perseveres through 64 manual combinations, there still may be no proposed date that is sufficiently before the scientific convention to allow the issue of interest to be addressed and acted upon. The current systems do not resolve conflicts, e.g., the current systems do not identify which group or groups are most responsible for causing the greatest delay and do not offer to management an approach to resolve the conflict.

Clearly, there is a need for a conference scheduling system that does not suffer the deficiencies of current conference scheduling systems.

The approaches described in this section could be pursued, but are not necessarily approaches that have been previously conceived or pursued. Therefore, unless otherwise indicated herein, the approaches described in this section are not to be considered prior art to the claims in this application merely due to the presence of these approaches in this background section.

### SUMMARY OF THE INVENTION

Techniques are provided for resolving conflicts in scheduling conferences based on the definition of a priority for one or more recorded commitments already scheduled by a user.

In one set of embodiments, a method for scheduling a conference among multiple persons includes receiving a conference request to schedule a particular conference by receiving quorum data and limit data. Quorum data indicates a quorum of persons to conduct the particular conference; and limit data indicates a limit on a property of the particular conference, such as a limit on the date, time of day, location, language, travel cost, or other property of a conference. Availability data is received from a shared database that includes information about any recorded commitments of time for each person of a population of persons that includes all persons indicated in the quorum data. Also received is priority data that indicates an importance to an organization that a particular recorded commitment of a particular person of the population is honored. A proposed time interval for the particular conference is determined based on the conference request and the availability data and the priority data.

In some embodiments of this set, determining the proposed time interval includes determining a conflicted person whose recorded commitment blocks the particular conference. A priority of the recorded commitment is determined based on the priority data. It is determined whether the priority of the recorded commitment is lower than a priority of the particular conference. If so, then the conflicted person is marked as available for the particular conference during a time interval of the recorded commitment.

In some embodiments of this set, determining whether the priority of the recorded commitment is lower than the priority of the particular conference includes receiving data that indicates that a first organizer of the particular conference is at a higher echelon in the organization than is a second organizer for the prior commitment.

In some embodiments of this set, receiving the conference request includes receiving conference priority data that indicates an importance to the organization that the particular conference is held.

In some of these embodiments, determining the proposed time interval for the particular conference includes determining whether a conflict exists that blocks the particular conference. If it is determined that a conflict does not exist, then the priority of the particular conference is associated with an invitation to attend the particular conference at the proposed time.

In other sets of embodiments, a computer readable medium and a system are provided that implement the steps of the above methods.

These methods support the automatic or computer assisted resolution of conflicts in scheduling conferences among multiple persons within certain limits on some combination of the time, location, language or cost of the conference or other property of the conference.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a system with data and servers for resolving conflicts in scheduling a conference, according to an embodiment;

FIG. 2 is a block diagram that illustrates a hierarchy of priorities for scheduling a conference, according to an embodiment;

FIG. 3 is a flow diagram that illustrates a method for resolving conflicts in scheduling a conference, according to an embodiment; and

FIG. 4 is a block diagram that illustrates a computer system upon which an emobodiment of the invention may be implemented.

### DETAILED DESCRIPTION

A method and apparatus for scheduling a conference are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments of the invention are described in the context of using data from an electronic calendar, but the invention is not limited to this context. In other contexts, other data may be used instead of or in addition to data from an electronic calendar, such as flat files of scheduled conferences and attendees, electronic personnel travel requisitions, data indicating the presence of a user on a network (called herein “presence data”) including a wireless network, a large area network, the internet or a cellular telephone network, and data indicating resources scheduled for a conference, such as network equipment, conference room, and conference room equipment.

Presence data is used in several extant and emerging applications. For example, in instant messaging applications, such as AOL Instant Messenger (AIM) from America Online of Dulles, Va. and PresenceWorks of PresenceWorks, Inc in Alexandria Va., presence data indicates the instantaneous knowledge that someone is available online and reachable via instant messaging. More broadly, presence data indicates a dynamically changing set of channels, capabilities, characteristics, preferences and ability for persons to communicate and interact with each other. It includes such states as “online,” “offline,” “do not disturb,” “at lunch.” Some applications consider other availability information as presence data, including information that indicates, for a particular person, “try mobile phone first, then business line”, “always send e-mail” or “unavailable for conference calls, but available for webcasts.” In some applications, presence data may include physical location of the person such as “on travel in London,” or “at home,” or “in office” or “at company headquarters,” as well as a network address. In some applications, presence data indicates people on the same (virtual) location like a web page or a shared document. In some applications, presence data indicates people who are within the same cell (the geographical area covered by a cellular phone transmitter). Some Nokia wireless phones also provide presence data with the expectation that such information will prompt people to communicate more when they see that others are available and willing to talk. In some applications, presence data indicates location of a person or facility based on a positioning system, such as the Global Positioning System (GPS) widely used in commerce and by the military.

1. Structural Overview

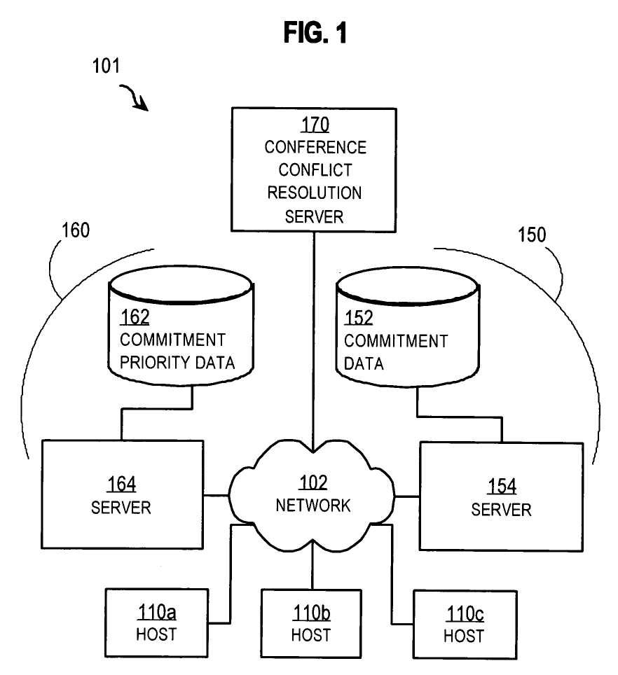

FIG. 1 is a block diagram that illustrates a system 101 with data and servers for scheduling a conference, according to an embodiment. The system 101 includes a network 102, hosts 110a, 110b, 110c (collectively referenced hereinafter as hosts 110), an availability database system 150, a priority data system 160, and a conference conflict resolution server 170.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer device on which the process operates. Similarly, the term “client” is conventionally used to refer to the process that makes the request, or the host computer device on which the process operates. As used herein, the terms “client” and “server” refer to the processes, rather than the host computer devices, unless otherwise clear from the context. In addition, a process executing as a server can be broken up to run as multiple servers on multiple hosts (sometimes called tiers) for reasons that include reliability, scalability, and redundancy, but not limited to those reasons.

The network 102 is any network that connects a variety of users of host computers, including, but not limited to, local area networks (LANs), wireless networks, wide-area networks (WAN), the Internet (a network of heterogeneous networks using the Internet Protocol, IP), and virtual private networks. In an embodiment using a single stand alone system, network 102 may be omitted.

The hosts 110 are computer devices to which a population of potential participants in conferences (the “conference population”), or their human agents such as secretaries and assistants, have access. The hosts are connected to network 102. For the purposes of illustration, three hosts 110a, 110b, 110c are shown in FIG. 1. In other embodiments more or fewer hosts are connected to network 102. In an embodiment using a single stand alone system, only one host, e.g., host 110a, is used. Hosts 110 include any device capable of accessing conference information or providing presence information or both, such as a desktop personal computer (PC), a laptop, a hand held personal digital assistant (PDA), a wireless phone, and other devices.

The system 101 includes an availability database system 150, such as a calendar database system, a presence data system, another availability system, or some combination. The availability database system 150 includes an availability database server 154 and commitment data 152 on one or more storage devices. The availability database server 154 controls the storage and retrieval of commitment data 152. For purposes of illustration, availability database server 154 is shown separate from hosts 110; but in some embodiments, availability database server 154 resides in part or in whole on one or more of hosts 110. Furthermore, for purposes of illustration, one availability server 154 is connected to one storage device with commitment data 122, but in other embodiments, the commitment data may be distributed over several data storage devices connected directly to one or more availability database servers like server 154, or connected indirectly to one or more servers through network 102. Any availability database system known in the art may be used as availability database system 120. In various embodiments, system 101 includes more or fewer availability database systems like system 150.

Calendar data typically includes one or more data structures that hold data indicating a person from the population and zero or more commitments of time for that person, including data indicating a start date and time and stop date and time for the commitment. In some embodiments, a description of the commitment, or a location associated with the commitment, or both, are included in the calendar data for each commitment.

The system 101 includes a priority data system 160, which includes a server 164 and priority data 162 on one or more storage devices. The server 164 controls the storage and retrieval of priority data 162. For purposes of illustration, server 164 is shown separate from hosts 110; but in some embodiments, server 164 resides in part or in whole on one or more of hosts 110. Furthermore, for purposes of illustration, one server 164 is connected to one storage device with priority data 162, but in other embodiments, the priority data may be distributed over several data storage devices connected directly to one or more servers like server 164, or connected indirectly to one or more servers through network 102. Any database system known in the art may be used as other priority data system 160. In some embodiments, one or more priority data servers like server 164 are embedded in an availability database server 154, such as a calendar database server. In some embodiments, some or all of priority data 162 is included on the same storage device or within the same storage records as the commitment data 152, such as a calendar database.

The system 101 includes a conference conflict resolution server 170. Conference conflict resolution server provides services to a conference scheduling server (not shown), which determines the time or attendees or location or other properties of a conference, or some combination. In some embodiments, the conference conflict resolution server 170 is part of the conference scheduling server. In some embodiments, the conference scheduling server is part of server 154. For purposes of illustration, conference conflict resolution server 170 is shown separate from hosts 110 and servers 154, 164; but in some embodiments, conference conflict resolution server 170 resides in part or in whole on one or more of hosts 110 or on a host with other depicted systems 150, 160 or as part of servers 154, 164. In some embodiments, the conference conflict resolution server 170 may be distributed over several hosts connected to network 102.

2. Functional Overview

Sufficient involvement by persons from the conference population to hold a conference is a quorum for the conference. Some persons are mandatory and must attend a conference. Such persons are said to belong to a mandatory group. Some persons are optional and the conference may be conducted without any of these optional persons. Such persons are said to belong to an optional group.

According to Ethier, cited above, a quorum for a conference is defined based on having one or more members from each of one or more representative groups. For members in a representative group, some minimum number must attend the conference but any of the members in the representative group can satisfy the minimum. Not all the members of the representative group need attend to satisfy the quorum.

By using representative groups to define a quorum, it is easier to avoid conflicts. A conference organizer attempting to schedule a meeting determines the type of expertise or authority that is important to conduct the business of a conference, and identifies two or more persons from the population that provide each desired expertise or authority. Those two or more persons for each desired expertise or authority constitute a representative group for the conference. A quorum can be defined by a combination of groups and a minimum number of members to attend from each group. Predefined groups may be used, such as departments or job classifications or email lists or combinations of these. The conference scheduling system of Ethier uses the representative groups defined for the quorum, the group rosters, and the calendar or other availability data for the people on the group rosters to determine when a conference can be held.

In various embodiments described in Ethier, the conference organizer may specify properties of the conference, such as its duration and a description of the topic, which the scheduling system uses in determining the conference time or for inviting persons to attend. The system may report not only on the time, but also give the list of invitees, their locations at the time of the conference, their notification addresses, and other data relevant to scheduling the meeting. In some embodiments, the system automatically sends invitations for the meeting to the invitees and processes responses.

Of many possible meeting times for the conference, embodiments of the system described in Ethier selects one along with zero or more alternatives. For example, as a default, the system may select the earliest time when a quorum can be met, and determine as alternatives the next two times when a quorum can be met, to be presented when the organizer or an invitee rejects the selected time. Instead of using the earliest time, in various embodiments, the system selects a conference that has the most people at a common location, or the most people speaking a common language, or the smallest differences in local times or other preference for conference properties. In some embodiments, the organizer can specify how to select among several possible meeting times using preference data.

In addition, in some embodiments described in Ethier, the organizer puts limits on the meeting. For example, the organizer specifies that the conference must occur before a certain date or in a certain range of dates, or that the conference be conducted in a particular language. These limits may be impossible to meet and still have a quorum. For example, it may be impossible to have the minimum number of persons from each representative group within a particular range of dates. If the limits can't be met with the current group and quorum definitions, the organizer is notified of a conflict. Often, the primary cause of the conflict is a group, e.g., a group whose members are completely committed throughout the date range. In some embodiments, the primary cause of the conflict is identified as a blocking group and reported to the organizer. A manager can use this information to remove the conflict, such as by assigning more staff to a department associated with the blocking group or reassigning tasks away from that department so that a member of the blocking group is freed to attend the conference.

In embodiments of the present invention, the conference conflict resolution server 170 receives priority information, such as priority data 162, associated with commitments stored as commitment data 152 in the availability database system 150 and uses the priority information to resolve any conflicts and determine a time for the particular conference. For example, in some embodiments, a commitment to a lower priority meeting is automatically identified by server 170 as a commitment that can be broken to schedule a conference with a higher priority. In some embodiments, the best lower priority commitment to break is identified by the server 170. In some embodiments, the server 170 presents the lower priority commitment to the conference organizer to allow the organizer to decide whether to break the commitment. In some embodiments, the server 170 automatically ignores the lower priority commitment and schedules a conference when the only conflict is with lower priority commitments.

3. Example Priority Data

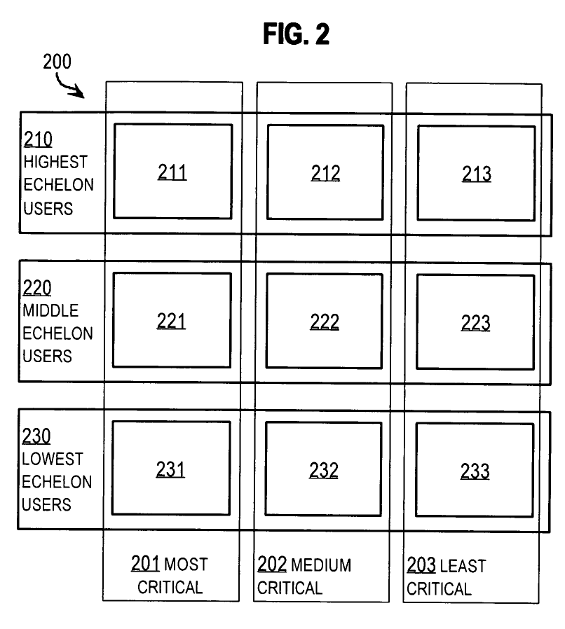

To illustrate a method, an example embodiment is described. FIG. 2 is a block diagram that illustrates a hierarchy 200 of priorities for scheduling a conference, according to an embodiment. In other embodiments, other hierarchies of priorities are used.

In the hierarchy 200 depicted in FIG. 2, users of a conference scheduling system are grouped according to the echelon they occupy within the organization using the scheduling system. At the highest echelon 210 is the highest executive of the organization, such as the provost of a university, the chief executive officer (CEO) of a corporation, the president of a trade association, or the head of a union, and that executive's cohorts, if any, to be grouped together for setting the highest priorities of the organization. At the lowest echelon 230 are users who do not have management responsibility for other users, and lower level mangers, if any, to be grouped together for setting their own priorities. Between the highest echelon 210 and lowest echelon 230 are zero or more other middle echelons, such as middle echelon 220. In the middle echelons, if any, are mangers between those in the highest echelon 210 and the lowest echelon 230 who are grouped together for setting middle priorities of the organization. In some embodiments, the echelon of each user is stored in dedicated priority database; in some embodiments the echelon of each user is stored in a different database, such as a personnel database. In either case, the echelon of each user constitutes part of priority data 162.

In some embodiments, the priority of the conference is based solely on the echelon of the organizer. In the illustrated embodiment, when an organizer uses a scheduling system, such as 101, to set up a conference, the organizer characterizes the criticality of the conference to the organization. The criticality of the conference is an indication of the harm that is suffered by the organization if the conference is not held within the limits specified for the conference. The more harm that befalls the organization without the conference, the more critical is the conference to the organization. By the same token, the criticality is an indication of the importance to the organization that the conference be held.

In the illustrated embodiment, the organizer is allowed to select among three degrees of criticality: “most critical” 201; “medium critical” 202; and “least critical” 203 for the echelon of the organizer. In other embodiments, more or fewer degrees of criticality are allowed. For example, an organizer in the highest echelon 210 designates a conference as most critical 211, medium critical 212 or least critical 213; an organizer in the middle echelon 220 designates a conference as most critical 221, medium critical 222 or least critical 223; an organizer in the lowest echelon 230 designates a conference as most critical 231, medium critical 232 or least critical 233.

The combination of the echelon of organizer and the degree of criticality is used to determine the priority of different meetings, and the commitments to attend those meetings. Any ranking of the combination of echelon and criticality may be used. In the illustrated embodiment, the most critical conference or commitment of the highest echelon organizer (priority 211) is ranked higher than the most critical conference or commitment of the middle echelon organizer (priority 221) which is ranked higher than the most critical conference or commitment of the lowest echelon organizer (priority 231). Similarly, the other degrees of criticality are ranked. It is more arbitrary how to rank priorities that differ in both echelon and degree of criticality. An example ranking of priorities is given in Table. 1. In other embodiments other rankings are used. In Table 1, the rank ordinal number increases with decreasing rank, i.e., the lowest rank ordinal number, rank 1, has the highest rank and therefore the highest priority.

TABLE 1
Ranking of priorities in illustrated embodiment.

| Rank | Priority | Echelon-criticality |
|---|---|---|
| 1 | 211 | Highest echelon-most critical |
| 2 | 221 | Middle echelon-most critical |
| 3 | 212 | Highest echelon-medium critical |
| 4 | 231 | Lowest echelon-most critical |
| 5 | 222 | Middle echelon-medium critical |
| 6 | 213 | Highest echelon-least critical |
| 7 | 232 | Lowest echelon-medium critical |
| 8 | 223 | Middle echelon-least critical |
| 9 | 233 | Lowest echelon-least critical |

In the illustrated embodiment, when a conference is scheduled and stored in the commitment data 152, either or both of the priority of the conference and the echelon-criticality of the conference is stored in the commitment priority data 162 and associated with the corresponding commitment in the commitment data 152. In some embodiments, when a conference is scheduled and stored in the commitment data 152, either or both of the criticality of the conference and the echelon of the conference organizer or attendees is stored in the commitment priority data 162 and associated with the corresponding commitment in the commitment data 152.

4. Method for Scheduling a Conference

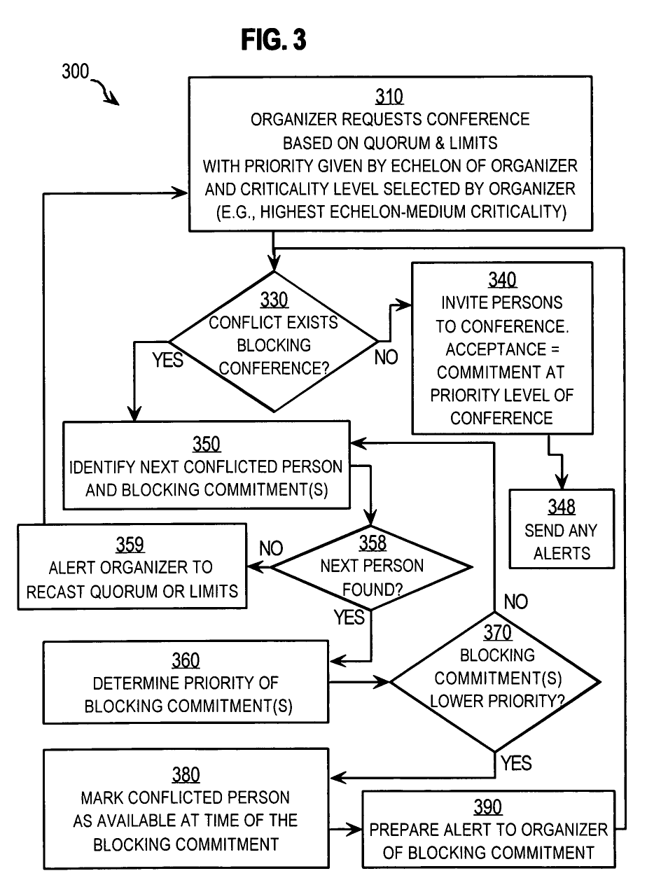

FIG. 3 is a flow diagram that illustrates a method 300 for scheduling a conference, according to an embodiment. Although steps are indicated in a particular order in FIG. 2, in other embodiments, the steps may be performed in a different order or overlapping in time.

In step 310, the scheduling process, e.g., server 154, receives a conference request including data indicating what constitutes a quorum for the conference and data that set limits on one or more properties of the conference, such as a latest date before which the conference should take place. Any method may be used for receiving this data. In some embodiments, some or all of the data is predefined and stored within source code or in files stored with the executable code or in files or a database accessible to the server. In some embodiments, the organizer inputs data for some or all of the request, either in response to prompts from the process or independently of prompts. In some embodiments, some or all of the data is based on predefined lists, such as email lists, department lists, job title lists, or some combination. In some embodiments, the request is included in a message sent to the server from a client process on a host 110 operated by an organizer.

In some embodiments, step 310 includes receiving priority data. In various embodiments, step 310 includes receiving priority data that indicates the echelon of the organizer who initiates the request or the echelon of a sponsor for the conference or a degree of criticality for the conference requested or some combination In the illustrated embodiment, step 310 includes both the echelon of the organizer and the degree of criticality of the conference input by the organizer. In some embodiments, the echelon of the organizer is determined by server 164 based on the user identification for the organizer and organizer echelon data stored in commitment priority data 162.

In an example of step 310 according to the illustrated embodiment, a request is received from manager h, a member of the highest echelon, to hold the conference described in the background section to determine what research to present at a scientific convention on the topic of possible prion-based diseases. Manger h has identified six representative groups described above (disciplines A, B, C, D, E, F) each with two members, designated here for purposes of illustration as members a1, a2 of group A; b1, b2 of group B; c1, c2 of group C; d1, d2 of group D; e1, e2 of group E; and f1, f2 of group F. It is further assumed for purposes of illustration that manager h has identified six members of an optional group O (o1, o2, o3, o4, o5, o6) and one member of a mandatory group M (h, the manager's self). It is further assumed that the manager h uses the scheduling system 101 to request a conference before May 15 of the current year. It is further assumed, for purposes of illustration that the manger h has indicated a degree of criticality for the meeting as medium criticality. Therefore, during step 310, the manager h makes a request for a quorum consisting of optional group O, mandatory group M, representative groups A, B, C, D, E, F with a date limit of before May 15 and a priority based on medium criticality. During step 310, the system 101 determines that the priority of the conference is highest echelon-medium critical priority (212 in FIG. 2).

In step 330, it is determined whether a conflict exists. In some embodiments, step 330 is performed by conflict resolution server 170; in some embodiments step 330 is performed by availability data server 154, as described in Ethier.

In Ethier, a scheduler, e.g., server 154, determines a proposed time for the conference that satisfies all the constraints imposed by the quorum definition and the limits, if possible. If such a time is found, then step 330 determines that there is no conflict. In some embodiments, one or more alternative proposed times for the conference that also satisfy the constraints are also determined. In one embodiment described in Ethier, step 330 includes determining multiple combinations of persons that would minimally satisfy the quorum. One or more meeting times can be found when all the persons of any of these combinations are available, even if those times are years away. If at any of these times additional persons from those groups are also available, those persons are also bonus potential attendees for the conference. The properties of the conferences associated with each combination are compared to the limits set for the conference. If any combination satisfies the limits, that combination provides a proposed time, or alternative proposed time, for conducting the conference, and there is no conflict.

If any combinations satisfy the quorum and limits, there is no conflict and control passes to step 340. In step 340, one or more of the combinations that satisfy the constraints are selected for determining the proposed time. Invitations to attend are sent to members of the quorum about the selected conference time. In some embodiments, the invitations include information about the place and other attendees of the conference and other properties of the conference. Persons who are among the combination that satisfies the constraints are notified that their attendance is mandatory for the particular meeting, whether they are members of a mandatory group or a representative group. Other persons are set invitations that indicate that their attendance is optional. In some embodiments of the present invention, the invitation includes some priority information about the meeting. For example, the invitation includes data that indicates the echelon of the organizer or the degree of criticality assigned by the organizer to the meeting, or both. In some embodiments, invitations to optional attendees include a lower priority or no priority information.

On some occasions, an invitee has more than one invitation outstanding for the same time period. According to some embodiments of step 330, a potential conflict is identified by the system when a mandatory attendee of the current conference being organized also has an invitation to a different conference. In some embodiments, when a potential conflict is identified by the system, the organizer is warned that there is a potential conflict at the selected time for the conference. The organizer is given the option to proceed with the invitation or to reject the particular combination and time that leads to the potential conflict. In some embodiments with multiple combinations or times that satisfy all the constraints, the system automatically selects a different combination or time or both. If there is no potential conflict at the different combination or time, then the invitation is sent for the different combination or time or both.

In some embodiments, the system determines whether the invitee who is mandatory for the conference being organized is also mandatory for the different conference. If the invitee is not mandatory for the different conference, then the potential conflict is resolved for the new conference being organized. The potential conflict can be resolved for the new conference in any manner. For example, in some embodiments, the invitation is sent and the invitee is obligated to reject the prior invitation to the different conference for which the invitee's attendance is not mandatory and accept the invitation for the conference for which the invitee's attendance is mandatory. In some embodiments, the system automatically deletes the non-mandatory prior invitation to the different conference.

If the invitee is also mandatory for the different conference, then, in some embodiments, the system determines the priority of the different conference. If the priority for the different conference is less than the priority for the conference being organized, then the potential conflict is resolved for the new conference being organized. The potential conflict can be resolved for the new conference in any manner, for example, as described above. If the priority of the different conference is greater than or equal to the priority of the conference being organized, then the potential conflict is not resolved. In some embodiments with a potential conflict involving a conference with greater or equal priority the invitee is treated as unavailable; in some embodiments the invitee is treated as available; and in some embodiments the conference organizer is alerted to the potential conflict.

It is assumed for purposes of illustration that the example conference described does not lead to a conflict and two combinations consisting of (a2, b2, c1, d1, e2, f2, h) and (a2, b2, c1, d2, e2, f2, h) are found that can convene on May 13 and a third combination of (a2, b2, c2, d1, e2, f1, h) is found that can convene on April 27. It is further assumed for purposes of illustration that the earlier time (third combination) is selected by the system and approved by the organizer, and invitations are sent to the members of the third combination that they are needed to convene the conference of priority 212 determined by a highest echelon and medium criticality on April 27. Invitations are also sent to other members of the groups (e.g., to optional group members o1, o2, o3, o4, o5, o6 and in some embodiments to a1, b1, c1, d2, e1, f2) that they may attend the conference, but their attendance is not mandatory and their commitment carries no priority. In the example of the illustrated embodiment, it is assumed that the invitations to optional attendees is set to a nominal priority, e.g., priority 999 with an associated large rank ordinal number, e.g., 999.

Once a person is sent an invitation, in many embodiments that person has the option of accepting or rejecting the invitation. If the person accepts the invitation, the acceptance is stored as a commitment to attend the meeting in commitment data 152 during step 340. If the conference accepted involves breaking a prior commitment for a different conference to resolve a conflict, as described in more detail below, control passes to step 348 to alert the organizer of the different conference that the prior commitment has been broken due to a higher priority conference.

In some embodiments, the priority data associated with the conference in the invitation is also stored in the commitment priority data 162 in association with the commitment data Any manner known in the art may be used to associate the commitment data 152 with the priority data 162, e.g., the data can have corresponding positions in different files, can be stored together, or can be stored with pointers to the corresponding data in another file. As described above, in some embodiments, the commitment priority data 162 is stored intermingled with the commitment data 152, even though they are depicted separately in FIG. 1. In some embodiments, the commitment by persons whose attendance is not mandatory is not associated with the same priority but is given a lower priority with a large rank ordinal number or no priority, such as included in the invitations described above. In some embodiments, the priority associated with the conference is based on the echelon of the organizer, as described above. In some embodiments, the priority associated with the conference is based on the highest echelon among the echelons of all the attendees who have committed to the conference.

For the above example of the illustrated embodiment, if all invitees whose attendance is mandatory (i.e., members of the third combination) accept, then they are committed to the conference on April 27 and the commitment carries a priority 211 of highest echelon and medium criticality. If any invitees whose attendance is not mandatory (i.e., members of the optional group O or other members of the representative groups A, B, C, D, E, F) accept, then they are committed to the conference on April 27 but their commitment is associated with a nominal priority (e.g., 999).

In some embodiments, step 340 includes a step (not shown) in which it is determined whether a mandatory participant for a selected conference time rejects the invitation. If so, control passes back to step 330 to automatically determine the next alternative that meets all of the criteria for the meeting (the next alternative may include the same mandatory participant but at a different time). In some embodiments, during step 340 the organizer (e.g., the owner of the meeting) is informed of the rejection and the next alternative so that the organizer can review the change before the previous invitation is withdrawn and the alternative is propagated to the new mandatory and optional attendees. If no alternative remains after a rejection, a conflict exists and control passes to step 350.

In an example of the illustrated embodiment, it is assumed that person d1 rejects the invitation. In this example, control passes back to step 330 which identifies one of the combinations on May 13 as the next alternative, e.g., (a2, b2, c1, d1, e2, f2, h), which includes the same person but on a different day.

In some embodiments, during step 340, an invitee who is a user at a lower echelon is not allowed to reject a meeting whose organizer is at a higher echelon. In some embodiments, during step 340, an invitee who at a lower echelon is not allowed to reject a meeting whose organizer is at a higher echelon, unless the organizer has indicated a degree of criticality less than most critical. In some embodiments, a degree of criticality less than most critical must also be accepted by the invitee of a lower echelon than the organizer.

In an example of the illustrated embodiment, it is further assumed for purposes of illustration that a user at a lower echelon is not allowed to reject a meeting whose organizer is at a higher echelon and that person d1 is a member of the middle echelon. Therefore, person d1 is not allowed to reject the invitation and the commitment is made.

In another example of the illustrated embodiment, it is further assumed for purposes of illustration that a user at a lower echelon is not allowed to reject a meeting whose organizer is at a higher echelon unless the organizer has indicated a degree of criticality less than most critical and that person d1 is a member of the middle echelon. Because the organizer has indicated a degree of criticality less than most critical, the person d1 can reject the invitation. Therefore, person d1 is allowed to reject the invitation in this example.

If no combination satisfies the limits, there is a conflict and control passes to step 350. In step 350, a person is identified who has a commitment that blocks the conference. Any method may be used to identify the person, called herein a “conflicted” person. In some embodiments of step 330, as described by Ethier, each combination that fails to satisfy the limits is assigned a measure of deviation from the limits. Any method may be used to determine the measure of deviation. In an example provided by Ethier, a combination that yields a proposed meeting time that is five months in the future when the time limit for the conference is two months is given a measure of deviation that is proportional to the time difference of three months. For another example, when the time limit for the conference is two months, the limit on the number of languages is two languages, and the travel cost limit is $25,000, then a combination that yields a proposed time that is five months in the future and proposed attendees that need at least four languages to communicate and involves $35,000 of estimated travel costs is given a measure of deviation based on a weighted sum of the differences in time (e.g., 3 months) languages (e.g., 2 languages) and estimated travel costs (e.g., $10,000). In some embodiments, the measure of deviation is based at least in part on the potential conflicts associated with the combination and time.

The properties associated with a combination for use in determining whether those properties satisfy the limits and for computing the measure of deviation, are based on the properties associated with the persons in the combination. The properties associated with persons in a combination are obtained from the availability data, such as commitment data 152, or other availability data (not shown in FIG. 1). Also included in the other availability data is nonpersonal information, such as information about facilities for holding audio, video or data teleconferences, information about conference room facilities, and information about estimated travel costs to those facilities from various locations.

In one embodiment of step 350, one or more of the groups is determined to be a blocking group that is most responsible for not satisfying the conference limits. Any method may be used to determine the blocking group. In an embodiment described in Ethier, the blocking group is determined as follows. One or more statistics of the measures of deviation found for the quorum is derived. For example a minimum, average, and maximum measure of deviation for the combinations based on the original quorum are determined. A test quorum is then defined that drops one of the groups from the quorum (e.g., makes the group an optional group, this is logically equivalent to assuming that one or more members of the group are made available, as described in more detail below). New statistics of the measures of deviation for the test quorum are derived. This process is repeated by reinserting the first dropped group and dropping a different group. The group for which removal leads to the greatest decrease in the statistics of the measures of deviation, or leads to one or more combinations that satisfy the conference limits, is determined to be a blocking group. There may be multiple blocking groups. In some embodiments, multiple blocking groups are ranked by the decrease in statistics of measures of deviation.

By definition, an optional group is never a blocking group. If the blocking group is a mandatory group, then the person in the group most responsible for not satisfying the limits is identified as a blocking person. Any method may be used to determine the person in a mandatory group who is most responsible for not satisfying the conference limits. In some embodiments, the persons in the blocking mandatory group are ranked by the decrease in statistics of measures of deviation achieved by eliminating that person from the group (which is logically equivalent to making that person available at one of the times the other persons that make the quorum are available).

One of the persons in a blocking group is selected as the next conflicted person. Any method may be used to select the next conflicted person. For example, the blocking person in the mandatory group is considered the conflicted person. In some embodiments, the persons in a representative group are presented as the next conflicted person in a random order or arbitrary order, e.g., in alphabetical order or order of entry into the group. In some embodiments, the persons in the blocking representative group are selected based on some other criterion, such as the echelon to which the person belongs.

In an example of the illustrated embodiment, it is assumed that the conference request described above leads to a conflict, i.e. no combination allows a conference to be held before May 15. It is further assumed for purposes of illustration that in step 350 it is determined that a meeting can be held before May 15, on April 27 or April 28, if representative group D is dropped from the quorum, but dropping any other single group still does not resolve the conflict. Group D is determined to be the next blocking group. It is assumed for purposes of illustration that the persons in the blocking representative group are selected based on the echelon to which the person belongs and that person d1 is in the middle echelon and person d2 is in the lowest echelon. In this example, person d2 is first determined to be the next conflicted person.

The next conflicted person is identified in step 350 in order to determine whether any commitments of that person may be ignored as having lower priority than the conference being planned. Each person in the blocking group is examined in turn. In step 358, it is determined whether there are any remaining persons in any remaining group to be examined for lower priority commitments. If not, control passes to step 359.

In an example of the illustrated embodiment, after the commitments of person d1 and d2 have been examined for lower priority commitments without success, there are no longer any other members of Group D to examine. After all persons of all groups are examined for lower priority commitments, control would pass to step 359.

In step 359, the organizer is alerted that no combination of available persons or persons with lower priority commitments can be found to achieve a quorum for the conference within the limits specified. The organizer is invited to change the request by changing the definition of a quorum or the acceptable limits for the conference. In some embodiments, the organizer is invited to increase the priority of the planned meeting. For example, the organizer is invited to increase the degree of criticality for the conference, or to have a person at a higher echelon in the organization sponsor the meeting and sanction a degree of criticality sufficient to bump prior commitments of persons in blocking groups. In some embodiments, the alert produced in step 359 indicates the lowest priority commitment that would have to be bumped in order to allow the conference to be scheduled. Thus the organizer would need to find a sponsor who can generate a higher priority in order to schedule this conference.

According to some embodiments, a conference organizer at a lower echelon can go up the organization chain of command and obtain a one time use “token” This token which can only be used once, provides the organizer with a higher echelon ranking for use in organizing one conference. In effect, the organizer has obtained a higher echelon sponsor for the conference. An example of a token in one implementation is something that looks like a random generated password (e.g. n368901x8P) so that a new valid value for the token can not be guessed from previously used valid tokens. The system allows the higher echelon sponsor to pass such a token to someone in a lower echelon. To prevent abuse in which a manager always passes tokens to all those who report to that manager, so that the manager's work is done at the expense of other groups, a limit is placed on the number of tokens in some embodiments. For example, at the beginning of the year a certain number of these tokens are generated and passed around the organization. The availability of a limited number of such tokens will allow people to have conference time with the upper echelon personnel without overwhelming the upper echelon personnel.

In some embodiments, a conference organizer is restricted from including in a quorum, or a group for a quorum, any person who is a certain number of echelons above the conference organizer in the organization. For example, an organizer would not be allowed to include in any group used to define a quorum a person three or more echelons higher in the organization. In some such embodiments, a conference organizer schedules a conference with an officer four echelons above the organizer using a token from a manager two echelons above the organizer.

If it is determined in step 358 that another blocking person is identified in step 350, then control passes to step 360. In step 360, the priorities of the commitments for the next blocking person are determined. For example, the priority data 162 associated with the commitment data 152 for the next conflicted person is retrieved by server 164 and passed to server 170. In some embodiments, step 360 examines all commitments by the next conflicted person within the time limits for the conference, if any. In some embodiments, if it is determined in step 330 that the rest of the quorum can meet at one or more proposed times if the blocking group is dropped from the quorum, then the priorities of commitments of the next conflicted person are determined at those proposed times. Control then passes to step 370.

In one example of the illustrated embodiment, the commitments of person d2 are examined for the two dates April 27 and April 28 when the rest of the quorum could convene. In another example of the illustrated embodiment, the commitments of person d2 are examined for the entire period until May 15. For purposes of illustration it is assumed that commitments of person d2 include a commitment on April 21 of priority 231 lowest echelon-most critical, a commitment on April 27 of priority 221 middle echelon-most critical, and a commitment on April 28 of 222 middle echelon-middle critical. These priorities are listed in Table 2.

TABLE 2
List of priorities of example commitments for a conflicted person.

| Date | Commitment priority | Echelon-criticality of commitment |
|---|---|---|
| 4/21 | 231 | lowest echelon-most critical |
| 4/27 | 221 | middle echelon-most critical |
| 4/28 | 222 | middle echelon-middle critical |

In step 370, it is determined whether the priority any of the one or more commitments of the next conflicted person are lower than the priority of the conference being planned. If not, control passes back to step 350 to select the next conflicted person. If so, control passes to step 380.

In some embodiments, the determination in step 370 is done automatically based on predetermined rankings of priorities, such as the rankings listed in Table 1 for an illustrated embodiment. In some embodiments, step 370 includes manual review of the blocking commitment by the organizer of the new conference. If the organizer of the new conference belongs to a higher echelon than the echelon associated with the commitment, then that organizer can override that commitment of the conflicted person. In some such embodiments, the criticality of the conference or commitment is not considered and is not input during step 310, nor stored in priority data association with a commitment during step 340.

In one example of the illustrated embodiment, the commitment on April 21 is not examined because it is not a date that allows the conference to be scheduled according to determinations made in step 330. The commitment on April 27 of priority 221 is determined not to be lower priority than conference priority 212 based on the rankings in Table 1; and the commitment on April 28 of 222 is determined to be lower priority based on those same rankings. In another example of the illustrated embodiment, the commitment on April 21 is examined and the commitment on April 21 of priority 231 is determined to be lower priority than conference priority 212 based on the rankings in Table 1. In yet another example of the illustrated embodiment, the higher echelon organizer determines that the middle echelon commitment on April 28 is lower priority than the conference being planned. In each of these examples, control passes to step 380.

In step 380, the conflicted person is marked as available for the times of the one or more lower-priority commitments. In some embodiments, the marking is temporary for the purposes of resolving conflicts and no permanent changes are made in the commitment data 152, until after a new proposed time for the conference is accepted by all mandatory attendees of the new conference. In some embodiments, step 380 includes permanently making a commitment and changing the commitment data 152. For example, if one date is known to accommodate the conference if the blocking group can be changed because of determinations made in step 330 and that date has a lower priority commitment, then step 380 includes automatically committing the conflicted person to the new conference on that date. Control then passes to step 390.

In step 390 an alert is prepared that indicates that the conflicted person's commitment to one or more lower-priority commitments is being broken. The alert is not sent until the change is made to the commitment data 152, such as in step 348, after a new proposed time for the conference is accepted by all mandatory attendees of the new conference in step 340. After step 390, control passes back to step 330 to determine if a conflict still exists after the conflicted person is made available at the times of one or more lower-priority commitments.

If no conflicts are found in step 330, then control passes to step 340, as described above. Invitations are sent during step 340. If all invitations are accepted by persons mandatory to achieve a quorum, then control passes to step 348 to change the commitment data 152 and send alerts to organizers of the lower-priority commitments that were broken.

If conflicts are still found in step 330, then steps 350, 358, 360, 370, 380 are repeated to render further lower-priority commitments available for the higher priority conference, until the higher priority conference can be scheduled. If after making all lower priority commitments of all persons in all groups available a conference can still not be scheduled control passes to step 359 to alert the organizer.

Using the method 300, lower priority commitments are broken to allow a higher priority conference to be scheduled. In the illustrated embodiment, lower priority commitments are broken only if a conflict exists that prevents holding the conference at another time without conflicts.

In other embodiments, other methods are used. For example, in some embodiments, conflicts are resolved before they arise by considering during the initial scheduling effort that every member of each group is available for a particular conference if the person has a commitment with a lower priority. Method 300 is superior to such a method in that method 300 only overrides a prior commitment if no time can be scheduled when there are no conflicts.

In some embodiments described above, each combination of persons that satisfies a quorum is considered separately. An advantage of such embodiments is that, once a particular person in the representative group has had a lower priority commitment broken so that the particular person can attend the conference as part of one combination the other members of the same representative group are not pressed to break their lower priority commitments. The rest of the members of the same group receive invitations that indicate those members are not mandatory for the conference. Thus all the members of lower echelons and attendees of lower echelon meetings are not compelled to attend a conference where their presence is not mandatory just because the conference is called by or attains a higher echelon or priority.

5. Hardware Overview

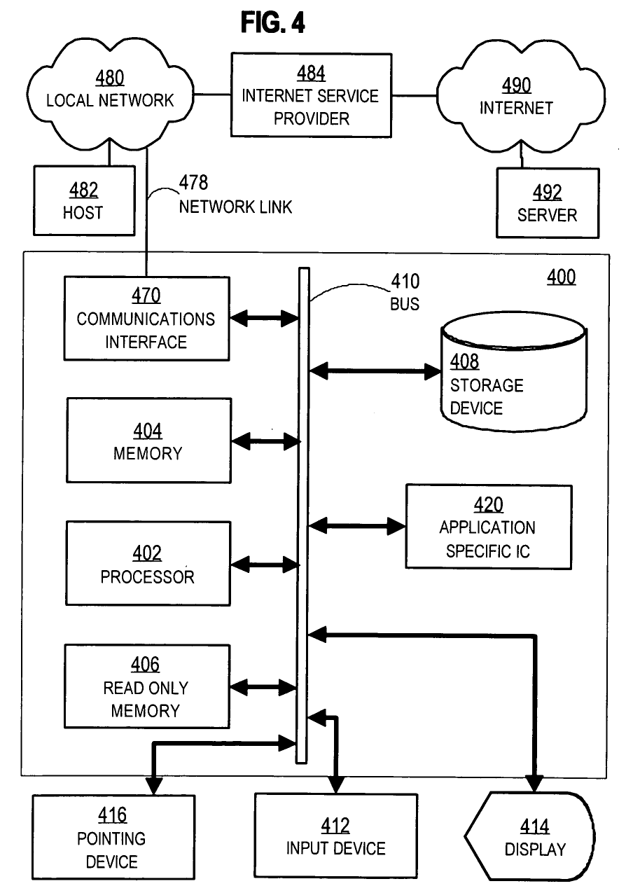

FIG. 4 is a block diagram that illustrates a computer system 400 upon which an embodiment of the invention may be implemented. Computer system 400 includes a communication mechanism such as a bus 410 for passing information between other internal and external components of the computer system 400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). A sequence of binary digits constitutes digital data that is used to represent a number or code for a character. A bus 410 includes many parallel conductors of information so that information is transferred quickly among devices coupled to the bus 410. One or more processors 402 for processing information are coupled with the bus 410. A processor 402 performs a set of operations on information. The set of operations include bringing information in from the bus 410 and placing information on the bus 410. The set of operations also typically include comparing two or more units of information, shifting positions of units of information, and combining two or more units of information, such as by addition or multiplication. A sequence of operations to be executed by the processor 402 constitute computer instructions.

Computer system 400 also includes a memory 404 coupled to bus 410. The memory 404, such as a random access memory (RAM) or other dynamic storage device, stores information including computer instructions. Dynamic memory allows information stored therein to be changed by the computer system 400. RAM allows a unit of information stored at a location called a memory address to be stored and retrieved independently of information at neighboring addresses. The memory 404 is also used by the processor 402 to store temporary values during execution of computer instructions. The computer system 400 also includes a read only memory (ROM) 406 or other static storage device coupled to the bus 410 for storing static information, including instructions, that is not changed by the computer system 400. Also coupled to bus 410 is a non-volatile (persistent) storage device 408, such as a magnetic disk or optical disk, for storing information, including instructions, that persists even when the computer system 400 is turned off or otherwise loses power.

Information, including instructions, is provided to the bus 410 for use by the processor from an external input device 412, such as a keyboard containing alphanumeric keys operated by a human user, or a sensor. A sensor detects conditions in its vicinity and transforms those detections into signals compatible with the signals used to represent information in computer system 400. Other external devices coupled to bus 410, used primarily for interacting with humans, include a display device 414, such as a cathode ray tube (CRT) or a liquid crystal display (LCD), for presenting images, and a pointing device 416, such as a mouse or a trackball or cursor direction keys, for controlling a position of a small cursor image presented on the display 414 and issuing commands associated with graphical elements presented on the display 414.

In the illustrated embodiment, special purpose hardware, such as an application specific integrated circuit (IC) 420, is coupled to bus 410. The special purpose hardware is configured to perform operations not performed by processor 402 quickly enough for special purposes. Examples of application specific ICs include graphics accelerator cards for generating images for display 414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 400 also includes one or more instances of a communications interface 470 coupled to bus 410. Communication interface 470 provides a two-way communication coupling to a variety of external devices that operate with their own processors, such as printers, scanners and external disks. In general the coupling is with a network link 478 that is connected to a local network 480 to which a variety of external devices with their own processors are connected. For example, communication interface 470 may be a parallel port or a serial port or a universal serial bus (USB) port on a personal computer. In some embodiments, communications interface 470 is an integrated services digital network (ISDN) card or a digital subscriber line (DSL) card or a telephone modem that provides an information communication connection to a corresponding type of telephone line. In some embodiments, a communication interface 470 is a cable modem that converts signals on bus 410 into signals for a communication connection over a coaxial cable or into optical signals for a communication connection over a fiber optic cable. As another example, communications interface 470 may be a local area network (LAN) card to provide a data communication connection to a compatible LAN, such as Ethernet. Wireless links may also be implemented. For wireless links, the communications interface 470 sends and receives electrical, acoustic or electromagnetic signals, including infrared and optical signals, that carry information streams, such as digital data. Such signals are examples of carrier waves.

The term computer-readable medium is used herein to refer to any medium that participates in providing instructions to processor 402 for execution. Such a medium may take many forms, including, but not limited to, nonvolatile media, volatile media and transmission media. Non-volatile media include, for example, optical or magnetic disks, such as storage device 408. Volatile media include, for example, dynamic memory 404. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 478 typically provides information communication through one or more networks to other devices that use or process the information. For example, network link 478 may provide a connection through local network 480 to a host computer 482 or to equipment 484 operated by an Internet Service Provider (ISP). ISP equipment 484 in turn provides data communication services through the public, world-wide packet-switching communication network of networks now commonly referred to as the Internet 490. A computer called a server 492 connected to the Internet provides a service in response to information received over the Internet. For example, server 492 provides information representing video data for presentation at display 414.

The invention is related to the use of computer system 400 for implementing the techniques described herein. According to one embodiment of the invention, those techniques are performed by computer system 400 in response to processor 402 executing one or more sequences of one or more instructions contained in memory 404. Such instructions, also called software and program code, may be read into memory 404 from another computer-readable medium such as storage device 408. Execution of the sequences of instructions contained in memory 404 causes processor 402 to perform the method steps described herein. In alternative embodiments, hardware, such as application specific integrated circuit 420, may be used in place of or in combination with software to implement the invention. Thus, embodiments of the invention are not limited to any specific combination of hardware and software.

The signals transmitted over network link 478 and other networks through communications interface 470, which carry information to and from computer system 400, are exemplary forms of carrier waves. Computer system 400 can send and receive information, including program code, through the networks 480, 490 among others, through network link 478 and communications interface 470. In an example using the Internet 490, a server 492 transmits program code for a particular application, requested by a message sent from computer 400, through Internet 490, ISP equipment 484, local network 480 and communications interface 470. The received code may be executed by processor 402 as it is received, or may be stored in storage device 408 or other non-volatile storage for later execution, or both. In this manner, computer system 400 may obtain application program code in the form of a carrier wave.

Various forms of computer readable media may be involved in carrying one or more sequence of instructions or data or both to processor 402 for execution. For example, instructions and data may initially be carried on a magnetic disk of a remote computer such as host 482. The remote computer loads the instructions and data into its dynamic memory and sends the instructions and data over a telephone line using a modem. A modem local to the computer system 400 receives the instructions and data on a telephone line and uses an infra-red transmitter to convert the instructions and data to an infra-red signal, a carrier wave serving as the network link 478. An infrared detector serving as communications interface 470 receives the instructions and data carried in the infrared signal and places information representing the instructions and data onto bus 410. Bus 410 carries the information to memory 404 from which processor 402 retrieves and executes the instructions using some of the data sent with the instructions. The instructions and data received in memory 404 may optionally be stored on storage device 408, either before or after execution by the processor 402.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for scheduling a conference among multiple persons, comprising the steps of:
receiving a conference request to schedule a particular conference by receiving quorum data that indicates a quorum of persons to conduct the particular conference and receiving limit data that indicates a limit on a property of the particular conference;
receiving availability data from a shared database that includes information about a recorded commitment of time for each person of a population plurality of persons that includes all persons indicated in the quorum data;
receiving priority data that indicates an importance to an organization that a particular recorded commitment of a particular person of the population plurality of persons is honored; and
determining a proposed time interval for the particular conference based on the conference request and the availability data and the priority data.

2. The method as recited in claim 1, said step of receiving availability data further comprising receiving at least one of scheduled availability data based on data in a shared calendar database and current availability data based on presence data.

3. The method as recited in claim 1, said step of receiving priority data further comprising receiving priority data based on data in a shared calendar database.

4. The method as recited in claim 1, said step of determining the proposed time interval for the particular conference further comprising the steps of
determining a conflicted person whose recorded commitment blocks the particular conference;
determining a priority of the recorded commitment based on the priority data;
determining whether the priority of the recorded commitment is lower than a priority of the particular conference; and
if it is determined that the priority of the recorded commitment is lower than the priority of the particular conference, then rendering the conflicted person available for the particular conference during a time interval of the recorded commitment.

5. The method as recited in claim 4, said step of determining whether the priority of the recorded commitment is lower than the priority of the particular conference further comprises the step of receiving echelon data that indicates whether a first organizer of the particular conference is at a higher echelon in the organization than is a second organizer for the recorded commitment.

6. The method as recited in claim 4, said step of determining the priority of the recorded commitment further comprises determining the priority of the recorded commitment based on a highest echelon of all attendees of a second conference corresponding to the recorded commitment.

7. The method as recited in claim 6, said step of determining whether the priority of the recorded commitment is lower than the priority of the particular conference further comprises the step of receiving echelon data that indicates whether an attendee of the particular conference is at a higher echelon in the organization than are all attendees of the second conference.

8. The method as recited in claim 5, said step of determining whether the priority of the recorded commitment is lower than the priority of the particular conference further comprises the step of receiving input data indicating whether the first organizer has determined that the priority of the recorded commitment is lower than the priority of the particular conference.

9. The method as recited in claim 4, said step of determining whether the priority of the recorded commitment is lower than the priority of the particular conference further comprises the step of receiving data indicating whether a priority associated with a token obtained by an organizer of the particular conference from a member of a higher echelon than the organizer is greater than the priority of the recorded commitment.

10. The method as recited in claim 4, further comprising the steps of:
determining whether the conflicted person becomes committed to the particular conference; and
if it is determined that the conflicted person becomes committed to the particular conference, then alerting an organizer for the recorded commitment that the conflicted person is breaking the recorded commitment.

11. The method as recited in claim 1, wherein said step of receiving the conference request further comprises the step of receiving conference priority data that indicates an importance to the organization that the particular conference is held.

12. The method as recited in claim 11, said step of determining the proposed time interval for the particular conference further comprising the steps of:
determining a person whose recorded commitment blocks the particular conference;
determining a priority of the recorded commitment based on the priority data;
determining a priority of the particular conference based on the conference priority data;
determining whether the priority of the recorded commitment is lower than the priority of the particular conference; and
if it is determined that the priority of the recorded commitment is lower than the priority of the particular conference, then rendering the person available for the particular conference during a time interval of the recorded commitment.

13. The method as recited in claim 1, said step of receiving the quorum data further comprising receiving quorum data that indicates that the quorum for the particular conference includes a minimum number of persons in a first group of persons of the population plurality of persons and less than all persons from the first group of persons, whereby the first group is a representative group of persons.

14. The method as recited in claim 1, said step of receiving the quorum data further comprising receiving quorum data that indicates no person at an echelon in the organization which is higher by more than a particular difference above a conference echelon obtained by an organizer of the particular conference.

15. The method as recited in claim 14, said step of receiving the quorum data further comprising receiving quorum data that indicates a conference echelon obtained by an organizer of the particular conference is the same as an echelon of the organizer.

16. The method as recited in claim 14, said step of receiving the quorum data further comprising receiving quorum data that indicates a conference echelon obtained by an organizer of the particular conference is greater than an echelon of the organizer.

17. The method as recited in claim 1, said step of receiving the limit data further comprising receiving limit data that indicates that said property of the particular conference includes at least one of a date, a time of day, a location, a common language, and a travel cost.

18. The method as recited in claim 11, said step of determining the proposed time interval for the particular conference further comprising the steps of:
determining whether a conflict exists that blocks the particular conference; and
if it is determined that a conflict does not exist, then associating the priority of the particular conference with an invitation to attend the particular conference at the proposed time.

19. The method as recited in claim 18, the method further comprising the steps of:
receiving a commitment to attend the particular conference from a person whose attendance satisfies the quorum; and
storing the priority of the particular conference in association with availability data that indicates the commitment to attend the particular conference by the person whose attendance satisfies the quorum.

20. A method for scheduling a conference among multiple persons, comprising the steps of:
receiving a conference request to schedule a particular conference by receiving quorum data that indicates a quorum of persons to conduct the particular conference and receiving limit data that indicates a limit on a property of the particular conference;
receiving availability data from a shared database that includes information about a commitment of time for each person of a population plurality of persons that includes all persons indicated in the quorum data;
receiving priority data that indicates an importance to an organization that a particular recorded commitment of a particular person of the population plurality of persons is honored; and
determining a proposed time interval for the particular conference based on the conference request and the availability data and the priority data, including:
determining a conflicted person whose recorded commitment blocks the particular conference;
determining a priority of the recorded commitment based on the priority data;
determining whether the priority of the recorded commitment is lower than a priority of the particular conference by receiving echelon data that indicates at least one of
whether a first organizer of the particular conference is at a higher echelon in the organization than is a second organizer for the recorded commitment,
whether an attendee of the particular conference is at a higher echelon in the organization than are all attendees of a second conference for the recorded commitment
whether the first organizer has determined that the priority of the recorded commitment is lower than the priority of the particular conference, and
whether a priority associated with a token obtained by an organizer of the particular conference from a member of a higher echelon than the organizer is greater than the priority of the recorded commitment;
if it is determined that the priority of the recorded commitment is lower than the priority of the particular conference, then rendering the conflicted person available for the particular conference during a time interval of the recorded commitment;
determining whether the conflicted person becomes committed to the particular conference; and
if it is determined that the conflicted person becomes committed to the particular conference, then alerting an organizer for the recorded commitment that the conflicted person is breaking the recorded commitment.

21. A computer-readable medium carrying one or more sequences of instructions for scheduling a conference among multiple persons, wherein execution of the one or more sequences of instructions by one or more processors causes the one or more processors to perform the steps of:
receiving a conference request to schedule a particular conference by receiving quorum data that indicates a quorum of persons to conduct the particular conference and receiving limit data that indicates a limit on a property of the particular conference;
receiving availability data from a shared database that includes information about a commitment of time for each person of a population plurality of persons that includes all persons indicated in the quorum data;
receiving priority data that indicates an importance to an organization that a particular recorded commitment of a particular person of the population plurality of persons is honored; and
determining a proposed time interval for the particular conference based on the conference request and the availability data and the priority data.

22. The computer-readable medium as recited in claim 21, said step of receiving availability data further comprising receiving at least one of scheduled availability data based on data in a shared calendar database and current availability data based on presence data.

23. The computer-readable medium as recited in claim 21, said step of receiving priority data further comprising receiving priority data based on data in a shared calendar database.

24. The computer-readable medium as recited in claim 21, said step of determining the proposed time interval for the particular conference further comprising the steps of
determining a person whose recorded commitment blocks the particular conference;
determining a priority of the recorded commitment based on the priority data;
determining whether the priority of the recorded commitment is lower than a priority of the particular conference; and
if it is determined that the priority of the recorded commitment is lower than the priority of the particular conference, then breaking the recorded commitment to render the person available for the particular conference.

25. The computer-readable medium as recited in claim 24, said step of determining whether the priority of the recorded commitment is lower than the priority of the particular conference further comprises the step of receiving echelon data that indicates whether a first organizer of the particular conference is at a higher echelon in the organization than is a second organizer for the recorded commitment.

26. The computer-readable medium as recited in claim 25, said step of determining whether the priority of the recorded commitment is lower than the priority of the particular conference further comprises the step of receiving input data indicating whether the first organizer has determined that the priority of the recorded commitment is lower than the priority of the particular conference.

27. The computer-readable medium as recited in claim 24, wherein execution of the one or more sequences of instructions further causes the one or more processors to perform the steps of:
determining whether the person is committed to the particular conference; and
if it is determined that the person is committed to the particular conference, then alerting an organizer for the recorded commitment that the person is breaking the recorded commitment.

28. The computer-readable medium as recited in claim 21, wherein said step of receiving the conference request further comprises the step of receiving conference priority data that indicates an importance to the organization that the particular conference is held.

29. The computer-readable medium as recited in claim 28, said step of determining the proposed time interval for the particular conference further comprising the steps of:
determining a person whose recorded commitment blocks the particular conference;
determining a priority of the recorded commitment based on the priority data;
determining a priority of the particular conference based on the conference priority data;
determining whether the priority of the recorded commitment is lower than the priority of the particular conference; and
if it is determined that the priority of the recorded commitment is lower than the priority of the particular conference, then breaking the recorded commitment to render the person available for the conference.

30. The computer-readable medium as recited in claim 21, said step of receiving the quorum data further comprising receiving quorum data that indicates that the quorum for the particular conference includes a minimum number of persons in a first group of persons of the population plurality of persons and less than all persons from the first group of persons, whereby the first group is a representative group of persons.

31. The computer-readable medium as recited in claim 21, said step of receiving the limit data further comprising receiving limit data that indicates that said property of the particular conference includes at least one of a date, a time of day, a location, a common language, and a travel cost.

32. The computer-readable medium as recited in claim 28, said step of determining the proposed time interval for the particular conference further comprising the steps of:
determining whether a conflict exists that blocks the particular conference; and
if it is determined that a conflict does not exist, then associating the priority of the particular conference with an invitation to attend the particular conference at the proposed time.

33. The computer-readable medium as recited in claim 32, wherein execution of the one or more sequences of instructions further causes the one or more processors to perform the steps of
receiving a commitment to attend the particular conference from a person whose attendance satisfies the quorum; and
storing the priority of the particular conference in association with availability data that indicates the commitment to attend the particular conference by the person whose attendance satisfies the quorum.

34. An apparatus for scheduling a conference among multiple persons, comprising:
means for receiving a conference request to schedule a particular conference by receiving quorum data that indicates a quorum of persons to conduct the particular conference and receiving limit data that indicates a limit on a property of the particular conference;
means for receiving availability data from a shared database that includes information about a recorded commitment of time for each person of a population plurality of persons that includes all persons indicated in the quorum data;
means for receiving priority data that indicates an importance to an organization that a particular recorded commitment of a particular person of the population plurality of persons is honored; and
means for determining a proposed time interval for the particular conference based on the conference request and the availability data and the priority data.

35. An apparatus for scheduling a conference among multiple persons, comprising:
a network interface that is coupled to a network for communicating one or more packet flows therewith;
one or more processors; and
one or more stored sequences of instructions which, when executed by the one or more processors, cause the one or more processors to carry out the steps of:
receiving a conference request to schedule a particular conference by receiving quorum data that indicates a quorum of persons to conduct the particular conference and receiving limit data that indicates a limit on a property of the particular conference;
receiving availability data from a shared database that includes information about a recorded commitment of time for each person of a population plurality of persons that includes all persons indicated in the quorum data;
receiving priority data that indicates an importance to an organization that a particular recorded commitment of a particular person of the population plurality of persons is honored; and
determining a proposed time interval for the particular conference based on the conference request and the availability data and the priority data.

36. The apparatus as recited in claim 35, said step of receiving availability data further comprising receiving at least one of scheduled availability data based on data in a shared calendar database and current availability data based on presence data.

37. The apparatus as recited in claim 35, said step of receiving priority data further comprising receiving priority data based on data in a shared calendar database.

38. The apparatus as recited in claim 35, said step of determining the proposed time interval for the particular conference further comprising the steps of:
determining a conflicted person whose recorded commitment blocks the particular conference;
determining a priority of the recorded commitment based on the priority data;
determining whether the priority of the recorded commitment is lower than a priority of the particular conference; and
if it is determined that the priority of the recorded commitment is lower than the priority of the particular conference, then rendering the conflicted person available for the particular conference during a time interval of the recorded commitment.

39. The apparatus as recited in claim 38, said step of determining whether the priority of the recorded commitment is lower than the priority of the particular conference further comprises the step of receiving echelon data that indicates whether a first organizer of the particular conference is at a higher echelon in the organization than is a second organizer for the recorded commitment.

40. The apparatus as recited in claim 38, said step of determining the priority of the recorded commitment further comprises determining the priority of the recorded commitment based on a highest echelon of all attendees of a second conference corresponding to the recorded commitment.

41. The apparatus as recited in claim 40, said step of determining whether the priority of the recorded commitment is lower than the priority of the particular conference further comprises the step of receiving echelon data that indicates whether an attendee of the particular conference is at a higher echelon in the organization than are all attendees of the second conference.

42. The apparatus as recited in claim 39, said step of determining whether the priority of the recorded commitment is lower than the priority of the particular conference further comprises the step of receiving input data indicating whether the first organizer has determined that the priority of the recorded commitment is lower than the priority of the particular conference.

43. The apparatus as recited in claim 38, said step of determining whether the priority of the recorded commitment is lower than the priority of the particular conference further comprises the step of receiving data indicating whether a priority associated with a token obtained by an organizer of the particular conference from a member of a higher echelon than the organizer is greater than the priority of the recorded commitment.

44. The apparatus as recited in claim 38, wherein execution of the one or more sequences of instructions by the one or more processors further causes the one or more processors to carry out the steps of:
determining whether the conflicted person becomes committed to the particular conference; and
if it is determined that the conflicted person becomes committed to the particular conference, then alerting an organizer for the recorded commitment that the conflicted person is breaking the recorded commitment.

45. The apparatus as recited in claim 35, said step of receiving the conference request further comprises the step of receiving conference priority data that indicates an importance to the organization that the particular conference is held.

46. The apparatus as recited in claim 45, said step of determining the proposed time interval for the particular conference further comprising the steps of:
determining a person whose recorded commitment blocks the particular conference;
determining a priority of the recorded commitment based on the priority data;
determining a priority of the particular conference based on the conference priority data;
determining whether the priority of the recorded commitment is lower than the priority of the particular conference; and
if it is determined that the priority of the recorded commitment is lower than the priority of the particular conference, then rendering the person available for the particular conference during a time interval of the recorded commitment.

47. The apparatus as recited in claim 35, said step of receiving the quorum data further comprising receiving quorum data that indicates that the quorum for the particular conference includes a minimum number of persons in a first group of persons of the population plurality of persons and less than all persons from the first group of persons, whereby the first group is a representative group of persons.

48. The apparatus as recited in claim 35, said step of receiving the quorum data further comprising receiving quorum data that indicates no person at an echelon in the organization which is higher by more than a particular difference above a conference echelon obtained by an organizer of the particular conference.

49. The apparatus as recited in claim 48, said step of receiving the quorum data further comprising receiving quorum data that indicates a conference echelon obtained by an organizer of the particular conference is the same as an echelon of the organizer.

50. The apparatus as recited in claim 48, said step of receiving the quorum data further comprising receiving quorum data that indicates a conference echelon obtained by an organizer of the particular conference is greater than an echelon of the organizer.

51. The apparatus as recited in claim 35, said step of receiving the limit data further comprising receiving limit data that indicates that said property of the particular conference includes at least one of a date, a time of day, a location, a common language, and a travel cost.

52. The apparatus as recited in claim 45, said step of determining the proposed time interval for the particular conference further comprising the steps of:
determining whether a conflict exists that blocks the particular conference; and
if it is determined that a conflict does not exist, then associating the priority of the particular conference with an invitation to attend the particular conference at the proposed time.

53. The apparatus as recited in claim 52, wherein execution of the one or more sequences of instructions by the one or more processors further causes the one or more processors to carry out the steps of:
receiving a commitment to attend the particular conference from a person whose attendance satisfies the quorum; and
storing the priority of the particular conference in association with availability data that indicates the commitment to attend the particular conference by the person whose attendance satisfies the quorum.
